(19) United States
(12) Patent Application Publication
(10) Pub. No.: US 2025/0223201 A1
(43) Pub. Date: Jul. 10, 2025

(54) SUSTAINABLE INPUT STREAMS FOR ELECTROLYTIC GENERATION SYSTEM

(71) Applicant: Spraying Systems Co., Wheaton, IL (US)

(72) Inventors: Tyler WILLIAMS, St. Charles, IL (US); Jack BERNARD, Forest Park, IL (US); Tom ROTONDI, Manhattan, IL (US); Keith CRONCE, West Chicago, IL (US)

(21) Appl. No.: 19/015,258

(22) Filed: Jan. 9, 2025

Related U.S. Application Data
(60) Provisional application No. 63/619,021, filed on Jan. 9, 2024.

(51) Int. Cl. C02F 1/44; C02F 1/46; C25B 15/08

(52) U.S. Cl. CPC C02F 1/441; C02F 1/46; C25B 15/085; C02F 2209/05; C02F 2209/06; C02F 2303/22

(57) ABSTRACT

A system is described for producing solutions from respective outputs of an electrolytic cell. The system includes a reverse osmosis (RO) unit comprising a membrane for purifying water, and producing as output: an RO effluent, and an RO water product. An electrochemical activation system (ECAS) is provided that includes the electrolytic cell configured to: receive a catholyte input flow on a cathode cell side to produce a catholyte cleaning fluid, and receive an anolyte input flow on an anode cell side to produce an anolyte disinfecting fluid. At least one of the catholyte input flow and/or the anolyte input flow is provided from at least one of the RO effluent and/or the RO water product. At least one recirculation line and controllable valves are provided that are configured to controllably supply a recirculated fluid from output storage tanks to at least one input flow.

### CROSS-REFERENCE TO RELATED APPLICATIONS

This application claims the benefit of U.S. Provisional Application No. 63/619,021 filed Jan. 9, 2024, entitled “SUSTAINABLE INPUT STREAMS FOR ELECTROLYTIC GENERATION SYSTEM,” which is expressly incorporated by reference in its entirety, including any references contained therein.

### FIELD OF THE DISCLOSURE

The present disclosure relates to electrolytic generation systems.

### BACKGROUND OF THE INVENTION

Electrolyzing systems are known that produce electrolyzed waters within prescribed pH ranges for optimum usage, which can be operated for producing alkaline electrolyzed water and acidic electrolyzed water. An example of such system is described in U.S. Pat. No. 10,577,263, the contents of which are incorporated by reference in their entirety herein. The described system includes an electrolytic cartridge having a cathode cell and an anode cell, each comprising a pair of electrodes disposed in laterally spaced coplanar relation to each other, with a respective ion permeable membrane in spaced relation to the pairs of electrodes. The cells are separated by a common separator plate that maintains the respective ion permeable membranes in parallel relation with the respective electrodes and facilitates communication of brine solution from a brine bath to both cells. The cells further can be operated with staggered input currents and the electrolyzed water is redirected between the cells for optimum control of PH levels of the resulting products.

Such known systems are effective in producing acidic and alkaline water, which can be thereafter used for a variety of cleaning and disinfecting solutions. However, the operation of electrolyzing systems relies on a water supply, which can be a limited resource in certain environments. Moreover, their resulting output products may need to be maintained at an effective potency for prolonged periods if they are to be used reliably.

In various implementations, the electrolyzing systems may use reverse osmosis (RO) membranes to purify an incoming water stream to the system, which produces water and brine. The brine is thereafter used in an electrolytic cell to produce a catholyte solution and an anolyte solution. In other applications, RO membranes may be used as part of an industrial process, such as in desalination plants, water bottling facilities, drinking water for high volume use applications, processing facilities and the like. In such applications, water is softened to avoid clogging the RO membrane and to remove metals, such as Calcium and Magnesium, which may damage electrolytic cells. Treatment of water using RO membranes is not 100% efficient and produces an effluent stream that is sent to a waste drain.

### BRIEF SUMMARY OF THE INVENTION

The present disclosure is directed to electrolytic systems and methods carried out by such systems that both ensure potency of the resulting products are maintained and reduce waste in RO water purification facilities. By way of example, an electrolytic onsite generator is utilized to make a cleaning chemical from the effluent to lower water waste. The effect is usually desirable as the effluent contains natural chemical builders such as carbonates and sulphates that can assist in the cleaning product made. By way of a further example, potency of the products is maintained and ensured by recirculating the products at least partially back through the electrolytic system. In yet another illustrative implementation, rainwater is used as an input to the system.

In a first particular arrangement, a system is provided for producing both cleaning and disinfecting solutions from respective outputs of an electrolytic cell. The system includes a reverse osmosis (RO) unit comprising a membrane for purifying water, and producing as output: an RO effluent, and an RO water product. The system further includes an electrochemical activation system (ECAS) including the electrolytic cell configured to: receive a catholyte input flow on a cathode cell side to produce a catholyte cleaning fluid, and receive an anolyte input flow on an anode cell side to produce an anolyte disinfecting fluid. At least one of the catholyte input flow and/or the anolyte input flow is provided from at least one of the RO effluent and/or the RO water product. The system further includes a plurality of storage tanks including: a catholyte tank holding the catholyte cleaning fluid, and an anolyte tank holding the anolyte disinfecting fluid.

In a second particular arrangement, a system is provided for producing both cleaning and disinfecting solutions from respective outputs of an electrolytic cell. The system includes an input water line providing an input water flow, and an electrochemical activation system (ECAS) coupled to the input water line for receiving the input water flow, wherein the ECAS is configured to produce a catholyte cleaning fluid and an anolyte disinfecting fluid from the input water flow. The ECAS includes the electrolytic cell configured to: receive a catholyte input flow on a cathode cell side to produce the catholyte cleaning fluid, and receive an anolyte input flow on an anode cell side to produce the anolyte disinfecting fluid. The system further includes a plurality of storage tanks including: a catholyte tank holding the catholyte cleaning fluid, and an anolyte tank holding the anolyte disinfecting fluid. The system also includes at least one recirculation line and controllable valves configured to controllably supply a recirculated fluid from at least one of the plurality of storage tanks to at least one input flow taken from the group consisting of: the catholyte input flow, and the anolyte input flow.

### BRIEF DESCRIPTION OF THE SEVERAL VIEWS OF THE DRAWING

While the appended claims set forth the features of the present invention with particularity, the invention and its advantages are best understood from the following detailed description taken in conjunction with the accompanying drawings, of which:

FIG. 1 is a high-level schematic block diagram for an electrolytic system in accordance with the disclosure;

FIG. 2 is an illustrative depiction of an electrolytic system arrangement in accordance with the disclosure;

FIG. 3 is a detailed schematic block diagram of an electrolytic system in accordance with the disclosure;

FIGS. 4A and 4B are graphs for titration curves in accordance with the disclosure;

FIG. 5 is an illustrative functional/flow diagram of a chemical process in accordance with the disclosure;

FIG. 6 is a further detailed schematic block diagram of an electrolytic system in accordance with the disclosure;

FIG. 7 is a further detailed schematic block diagram of an electrolytic system in accordance with the disclosure; and

FIG. 8 is a further detailed schematic block diagram of an electrolytic system in accordance with the disclosure.

### DETAILED DESCRIPTION OF THE DRAWINGS

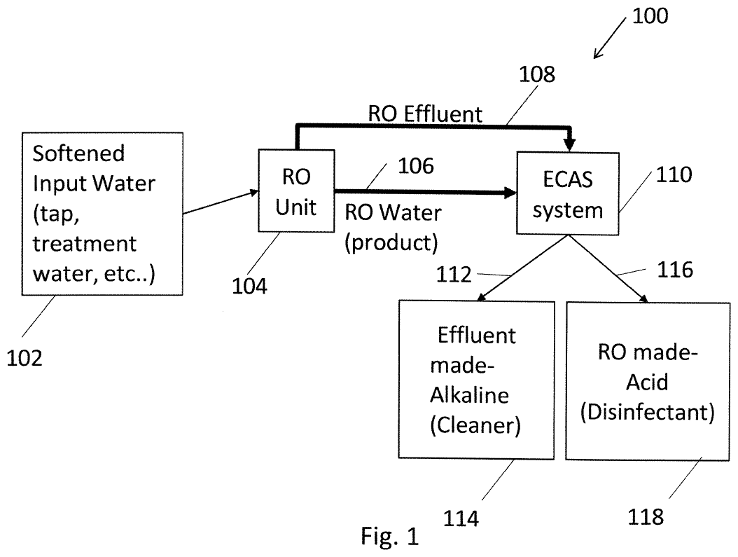

Turning to FIG. 1, a high-level schematic block diagram illustratively depicts an electrolytic system 100 (system 100) in accordance with the disclosure. The system 100 includes a water source 102 that supplies input water to a reverse osmosis (RO) unit 104. The supplied water from the water source 102 has been softened and is supplied, for example, from a municipal tap, a water softener and the like to the reverse osmosis (RO) unit 104. The RO unit 104 includes various components, conduits and systems in a known fashion. Such RO components include one or more RO membranes that separate input from the water source 102 into a water molecule stream (identified as RO water 106) and an RO effluent 108. The RO effluent 108 essentially includes impurities and salts separated from the incoming water from the water source 102. Both the RO water 106 and the RO effluent 108 are provided as input to an electro-chemical activation system (ECAS) 110. One example of an ECAS system 110 is an onsite generator such as the generator PS600-40 manufactured by the Pathosans company.

In accordance with the present disclosure, the ECAS system 110 operates to separate the brine or RO effluent 108 into a sodium hydroxide cleaning agent that is provided from a first outlet 112 and collected in a cleaner reservoir 114, and an acid provided at a second outlet 116 and collected in a disinfectant reservoir 118.

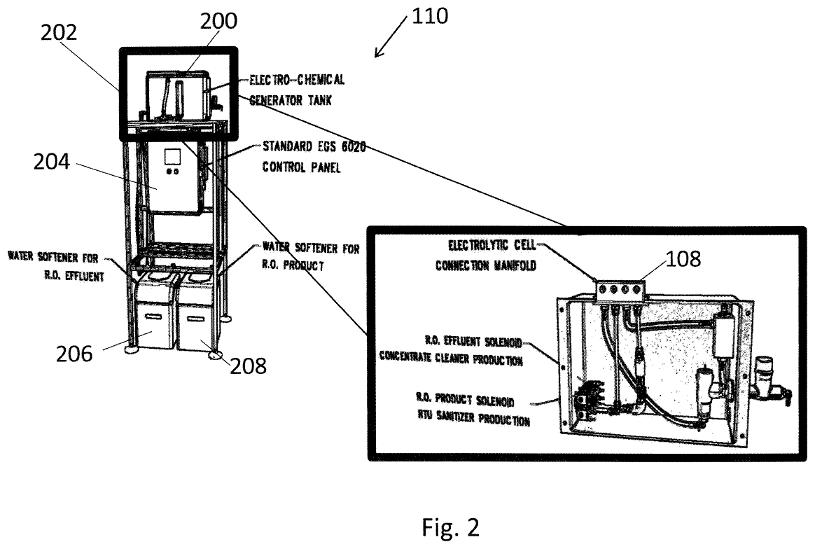

Turning to FIG. 2, an example of the ECAS system 110 is illustratively depicted, including functional components thereof. The ECAS system 110, by way of example, includes an electro-chemical generator tank 200 supported on a frame 202. A controller 204 is also supported on the frame 202. The ECAS system 110 also includes both: a water softener for RO effluent 206, and a water softener for RO water product 208. Within the electro-chemical generator tank 200 is an electrolytic cell (not shown) that is connected to a manifold having a first input for receiving the RO effluent 108 and a second input for receiving the RO water 106. The generator tank 200 further includes: a first output (see e.g., the first outlet 112 of FIG. 1) for providing alkaline cleaner fluid made from the effluent and provided to a first holding tank (see e.g., the cleaner reservoir 114), and a second output (see e.g., the second outlet 116) for providing the RO made acidic fluid that is used as a disinfectant and collected in a second holding tank (see e.g., the disinfectant reservoir 118).

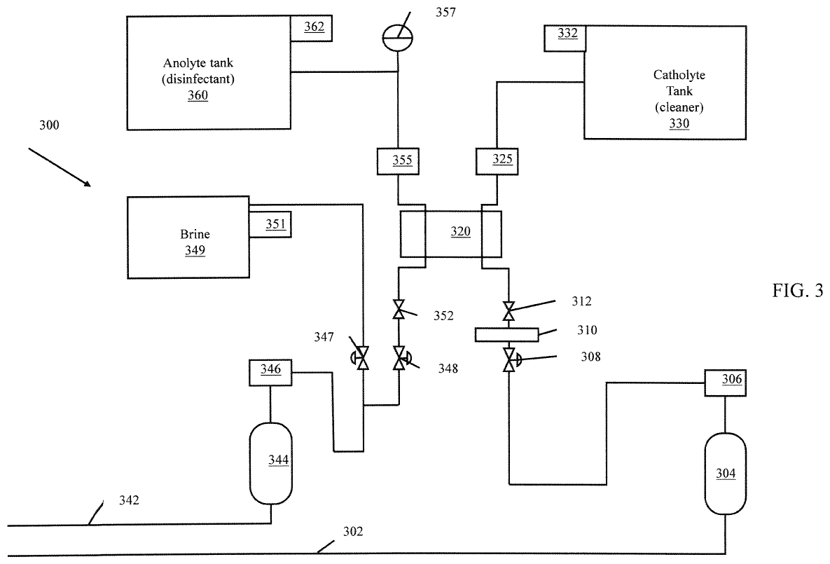

Turning to FIG. 3, a detailed schematic block diagram of an electrolytic system 300 is provided in accordance a particular illustrative example of the ECAS system 110 portion of the electrolytic system 100 of FIG. 1. The system 300 includes an RO effluent supply line 302 providing an RO effluent supply that is, by way of example, essentially brine generated from an RO membrane as a function of the ions removed from the main supply water. The RO effluent supply is provided via the RO effluent supply line 302 to an RO effluent water softener 304 that removes mineral salts that would precipitate out in the electrolytic process and heavy elements. The output of the water softener 304 passes via supply lines through a pressure sensor 306, an RO effluent supply solenoid valve 308, an input flow meter 310, and a cathode or catholyte flow control valve 312 before being provided as an input flow to a first (cathode) side of an electrolytic cell 320. A corresponding catholyte output flow, having passed through the electrolytic cell 320, is an electrolyzed solution that passes via a conduit, including a catholyte output flow sensor 325, for storage in a catholyte storage tank 330. The catholyte storage tank 330 is provided with catholyte sensors 332 that, by way of example, include a catholyte level sensor and a catholyte quality sensor.

With continued reference to FIG. 3, the system 300 further includes an RO product water supply line 342 providing an RO product supply (purified water). The RO product is provided via the RO product water supply line 342 to an RO product water softener 344. The output of the RO product water softener 344 passes via a supply line to an RO product pressure sensor 346. The output flow of the RO product pressure sensor 346 is thereafter split into a first RO product flow, regulated by a brine tank fill solenoid valve 347, passing to a brine tank 349. The brine tank 349 is provided with brine sensors 351 that, by way of example, include a brine level sensor and a fluid quality sensor. The second RO product flow, regulated by an RO product supply solenoid valve 348 and an anolyte flow control valve 352, is provided as an input to a second (anode) side of the electrolytic cell 320. A corresponding anolyte output flow, having passed through the anode side of the electrolytic cell 320, is an electrolyzed fluid that passes via a conduit, including an anolyte output flow sensor 355 and an anolyte pH sensor 357, for storage in an anolyte storage tank 360. The anolyte storage tank 360 is provided with anolyte sensors 362 that, by way of example, include an anolyte level sensor and an anolyte quality sensor.

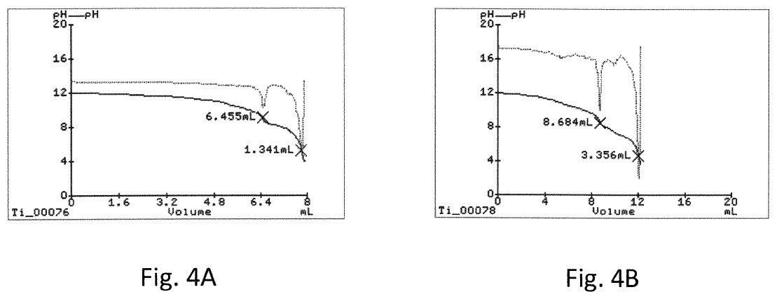

Turning to FIGS. 4A and 4B, exemplary graphs are provided showing titration curves of standard water samples. Such curves are utilized to determine total alkalinity and evaluate for other anomalies. The curve depicted in FIG. 4A shows a pH range of tap water feeding an RO unit. The curve depicted in FIG. 4B shows a pH range of RO effluent as a product of the tap water. The curves provided in FIGS. 4A and 4B, in combination, confirm that sodium carbonate is present at the output. For an experiment used to produce the illustrative curves of FIGS. 4A and 4B, the input to the RO system supplying the electrolytic system 300 (see FIG. 3) was 10 GPM potable tap water having 130 ppm TDS on average and 70% efficiency on filtration. The output was measured at 7 GPM RO produced with <1 ppm TDS, 3 GPM Effluent produced at 433 ppm TDS with the majority of components in the effluent being carbonate (CO₃²⁻). It is understood that higher TDS also increases conductivity lowering demand on electrolytic cell. Other properties of the two streams are provided in the Table below:

| | Buffer Capacity | Calcium (as | | |
|---|---|---|---|---|
| Location | (As GPG) | GPG of CaCO3) | Sulfate (ppm) | Other comments |
| Tap | 12.15 | 1.3 | 27 | 108 ppm of |
| | | | | alkalinity |
| Effluent | 27.68 | 3 | 103 | 360 ppm of |
| | | | | alkalinity |

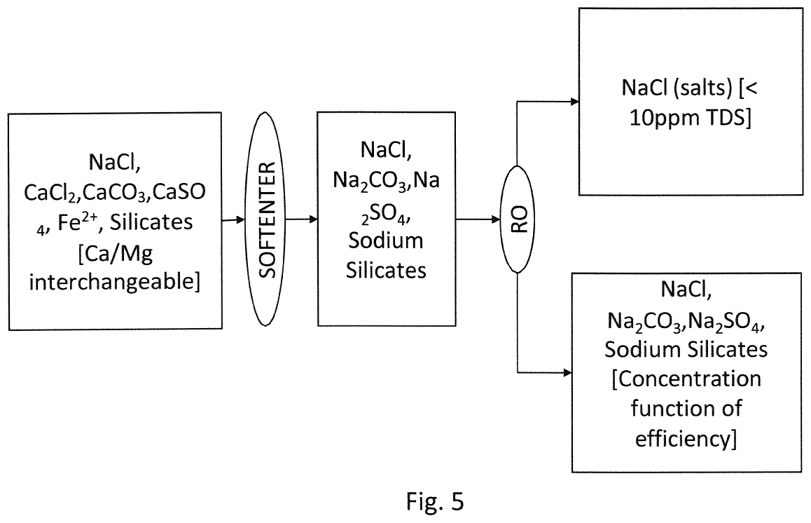

Turning to FIG. 5, an illustrative flow is summarized identifying/indicating various chemical processes occurring in an exemplary system. As can be seen, input water containing NaCl, CaCl₂, CaCO₃, CaSO₄, Fe²⁺, and Silicates, where Ca and Mg may be interchangeable, are provided to a softener. At the output of the softener, NaCl, Na₂CO₃, Na₂SO₄, and Sodium Silicates may be present. These are provided to an RO membrane, which provides NaCl (salts) [<10 ppm TDS] at the RO product outlet, and NaCl, Na₂CO₃, Na₂SO₄, and Sodium Silicates at the effluent output, the concentration of which is a function of the RO membrane efficiency.

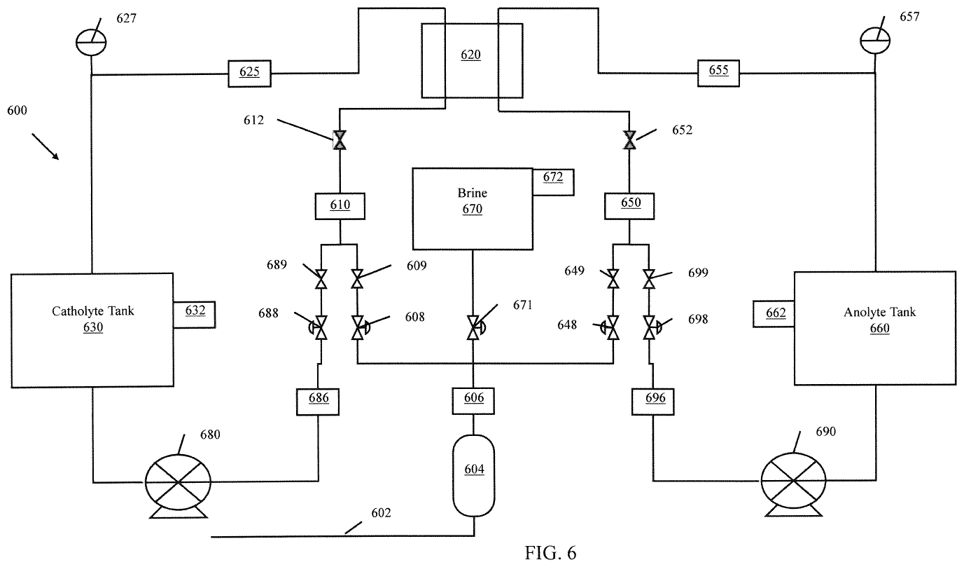

Turning to FIG. 6, a detailed schematic block diagram of an electrolytic system 600 is provided in accordance with a further particular illustrative example. In the electrolytic system 600, input water is provided via an input water line 602 to a water softener 604. Softened water output from the water softener 604 is provided to further fluid processing/handling components of the electrolytic system 600 after passing through a softened water pressure sensor 606. In the illustrative example, a brine tank 670 is provided as well as a catholyte pump 680 and an anolyte pump 690.

With continued reference to FIG. 6, a catholyte supply branch from an output of the softened water pressure sensor 606 includes a first catholyte supply solenoid valve 608 and a first catholyte supply check valve 609 through which softened water flows to a catholyte flow meter 610 and a catholyte flow control valve 612 before being provided as an input flow to a first (cathode) side of an electrolytic cell 620. A corresponding catholyte output flow, having passed through the electrolytic cell 620, is an electrolyzed solution that passes via a conduit, including a catholyte output flow sensor 625 and a catholyte pH sensor 627, for storage in a catholyte storage tank 630. The catholyte storage tank 630 is provided with catholyte sensors 632 that, by way of example, include a catholyte level sensor and a catholyte quality sensor. An output of the catholyte storage tank 630 is coupled via a supply line to an input of the catholyte pump 680. An output of the catholyte pump 680 is provided as an input to a catholyte supply line including a catholyte pressure sensor 686, a second catholyte supply solenoid valve 688 and a second catholyte supply check valve 689 through which catholyte flows to the catholyte flow meter 610.

With continued reference to FIG. 6, an anolyte supply branch from the output of the softened water pressure sensor 606 includes a first anolyte supply solenoid valve 648 and a first anolyte supply check valve 649 through which softened water flows to an anolyte flow meter 650 and an anolyte flow control valve 652 before being provided as an input flow to a second (anode) side of the electrolytic cell 620. A corresponding anolyte output flow, having passed through the electrolytic cell 620, is an electrolyzed solution that passes via a conduit, including an anolyte output flow sensor 655 and an anolyte pH sensor 657, for storage in an anolyte storage tank 660. The anolyte storage tank 660 is provided with anolyte sensors 662 that, by way of example, include an anolyte level sensor and an anolyte quality sensor. An output of the anolyte storage tank 660 is coupled via a supply line to an input of the anolyte pump 690. An output of the anolyte pump 690 is provided as an input to an anolyte supply line including an anolyte pressure sensor 696, a second anolyte supply solenoid valve 698 and a second anolyte supply check valve 699 through which anolyte flows to the anolyte flow meter 650.

With continued reference to FIG. 6, a brine tank supply branch from the output of the softened water pressure sensor 606 includes a brine tank supply solenoid valve 671 through which softened water is supplied to the brine tank 670. The brine tank 670 is provided with brine sensors 632 that, by way of example, include a brine level sensor and a brine quality sensor.

Having described components of the illustrative example of the system 600, attention is directed to operating the system 600. In a first operating mode, brine from a brine tank 670 (per the tank arrangement disclosed/depicted in U.S. Pat. No. 10,577,263, expressly incorporated herein by reference) and water from the water softener 604 are provided to the electrolytic cell 620 so the system operates to produce brine, anolyte and catholyte in accordance with the arrangement of the system 300 illustratively depicted in FIG. 3.

However, the valves and pumps of the system 600 can also be controlled and operate to recirculate anolyte and catholyte solution to increase concentration of catholyte and anolyte stored in the catholyte storage tank 630 and the anolyte storage tank 660, respectively. Such recharging of the respectively stored catholyte and anolyte is used, by way of example, to ensure sufficient potency, which may decrease over time with prolonged storage in the respective tanks. This arrangement/process allows for the regeneration of solution without adding more fresh water, and reduces water consumption if only one chemical is utilized. By way of a particular use of the recirculation modes of operation, a cleaner tank is currently empty. The cell must operate to make more and will make both products. However, rather than supplying fresh water to both sides, the system 600 can “recirculate” the product that is not currently being used and pass fresh water to the side of the cell that needs to perform the needed chemical reactions.

Thus, in a second (recirculating/recharging) operating mode, the pumps and valves of the system 600 are controlled to pump catholyte solution from the catholyte storage tank 630 by using the pump 680 to force the catholyte through the valves and sensors to the electrolytic cell 620 before being returned to the catholyte storage tank 630. In other illustrative examples, other mixing methods can be used such as a venturi mixer, a gravity fed system, and the like. Similarly, anolyte from the anolyte storage tank 660 is pumped by the pump 690 to the electrolytic cell 620 before being returned to the anolyte storage tank 660 to refresh or increase its potency. In the illustrative examples, the standard non-recirculated catholyte and anolyte supplies are connected to the same source as the brine fill. The recirculated catholyte and anolyte supplies are connected after the non-recirculated check valves on the edges of the diagram.

The chemical reactions occurring within the variously depicted fluid processing components of the system 600 are summarized herein below.

Primary Reactions: In the initial reaction, feed water (tap, usually) flows through the electrode chambers and a current is applied effectively splitting water in the following half reactions:

1) Anode: 2H₂O→O₂(g)+4H⁺(aq)+4e⁻

2) Cathode: 2H₂O+2e⁻→H₂(g)+2OH⁻

Cathode reactions: Hydroxide forms in the presence of other ions present in the wastewater. Cleaning uses up hydroxide, naturally occurring alkalinity supports buffers the cleaning solution allowing it to clean longer:
3) Cathode output (alkalinity):

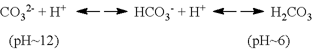

Additional ions left in solution have other desired cleaning effects: Silicates—clarifying agent, and Sulfates—buffer effect.

The electrolytically generated chemistry has two known properties that can be considered waste challenges: (1) both streams must be produced at the same time—imbalanced usage requires some produced chemistry to go to drain (or be disposed of); (2) shelf life—as the produced chemistry can only be stored for so long before the product has degraded to the point that is can no longer fulfill its purpose/function and disposal is necessary (˜30 days)

The systems and methods, in accordance with the present disclosure, utilize the above-summarized chemical reactions and a feed back arrangement of feeding stored catholyte and/or anolyte from their respective tanks back into the input stream to the electrolytic cell at some variable percentage (up to 100% replacement of input water by the recirculated catholyte or anolyte). This yields desired effects such as: increased cell efficiency and durability (by lowering voltage stress); increased shelf life by restoring/increasing strength of stored chemistry; lower waste stream as generated, stored chemistry replaces input water in the event of imbalanced use; and the ability to disinfect input water with system generated disinfectant (anolyte).

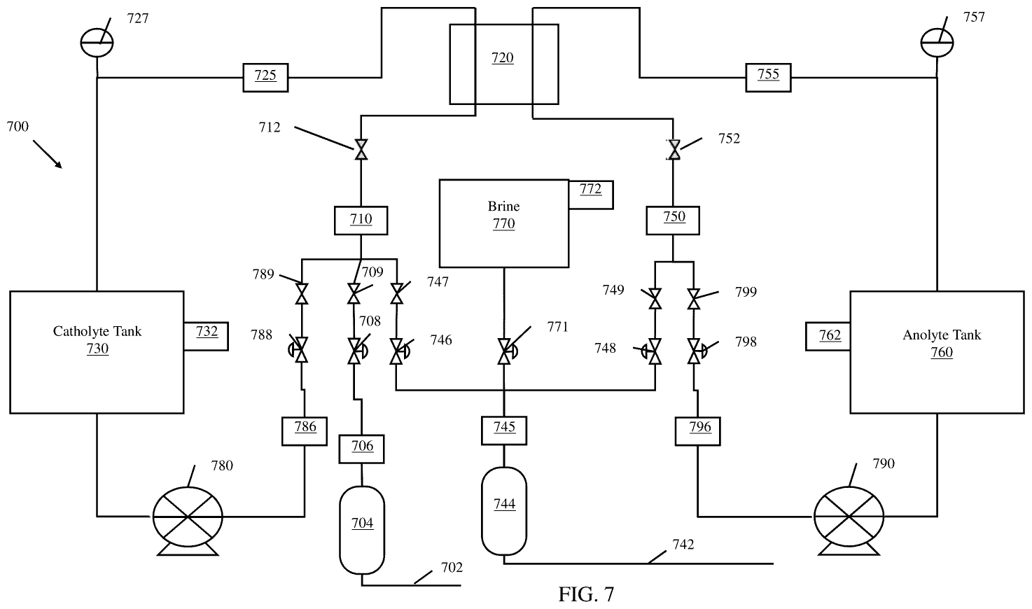

Turning to FIG. 7, a detailed schematic block diagram of an electrolytic system 700 is provided in accordance with yet another particular illustrative example where, instead of a single input water line (line 602 of FIG. 6), the system 700 utilizes an input arrangement of the type depicted in FIG. 3 where the input to the system 300 is obtained via RO effluent supply line 302 and RO product water supply line 304 from an RO system. The electrolytic system 700 includes an RO effluent supply line 702 providing an RO effluent supply that is, by way of example, essentially brine generated from an RO membrane as a function of the ions removed from the main supply water. The RO effluent supply is provided via the RO effluent supply line 702 to an RO effluent water softener 704 that removes mineral salts that would precipitate out in the electrolytic process and heavy elements. Softened water output from the RO effluent water softener 704 is provided to further fluid processing/handling components of the electrolytic system 700 after passing through a pressure sensor 706. In the illustrative example, a brine tank 770 is provided as well as a catholyte pump 780 and an anolyte pump 790.

With continued reference to FIG. 7, a catholyte supply branch from an output of the pressure sensor 706 includes a first catholyte supply solenoid valve 708 and a first catholyte supply check valve 709 through which softened water flows to a catholyte flow meter 710 and a catholyte flow control valve 712 before being provided as an input flow to a first (cathode) side of an electrolytic cell 720. A corresponding catholyte output flow, having passed through the electrolytic cell 720, is an electrolyzed solution that passes via a conduit, including a catholyte output flow sensor 725 and a catholyte pH sensor 727, for storage in a catholyte storage tank 730. The catholyte storage tank 730 is provided with catholyte sensors 732 that, by way of example, include a catholyte level sensor and a catholyte quality sensor. An output of the catholyte storage tank 730 is coupled via a supply line to an input of the catholyte pump 780. An output of the catholyte pump 780 is provided as an input to a catholyte supply line including a catholyte pressure sensor 786, a second catholyte supply solenoid valve 788 and a second catholyte supply check valve 789 through which catholyte flows to the catholyte flow meter 710.

With continued reference to FIG. 7, the system 700 further includes an RO product water supply line 742 providing an RO product supply (purified water). The RO product is provided via the RO product water supply line 742 to an RO product water softener 744. The output of the RO product water softener 744 passes via a supply line to an RO product pressure sensor 745. The output flow of the RO product pressure sensor 745 is thereafter split into: a catholyte supply branch, an anolyte supply branch, and a brine branch.

The anolyte supply branch from the output of the pressure sensor 745 includes a first anolyte supply solenoid valve 748 and a first anolyte supply check valve 749 through which softened water flows to an anolyte flow meter 750 and an anolyte flow control valve 752 before being provided as an input flow to a second (anode) side of the electrolytic cell 720. A corresponding anolyte output flow, having passed through the electrolytic cell 720, is an electrolyzed solution that passes via a conduit, including an anolyte output flow sensor 755 and an anolyte pH sensor 757, for storage in an anolyte storage tank 760. The anolyte storage tank 760 is provided with anolyte sensors 762 that, by way of example, include an anolyte level sensor and an anolyte quality sensor. An output of the anolyte storage tank 760 is coupled via a supply line to an input of the anolyte pump 790. An output of the anolyte pump 790 is provided as an input to an anolyte supply line including an anolyte pressure sensor 796, a second anolyte supply solenoid valve 798 and a second anolyte supply check valve 799 through which anolyte flows to the anolyte flow meter 750.

The catholyte supply branch from the output of the pressure sensor 745 includes a third catholyte supply solenoid valve 746 and a third catholyte supply check valve 747 through which softened water flows to the catholyte flow meter 710.

The brine tank supply branch from the pressure sensor 745 includes a brine tank supply solenoid valve 771 through which softened water is supplied to the brine tank 770. The brine tank 770 is provided with brine sensors 732 that, by way of example, include a brine level sensor and a brine quality sensor.

Operation of the system depicted in FIG. 7 is essentially the same as operation described herein above with regard to the system 600 of FIG. 6.

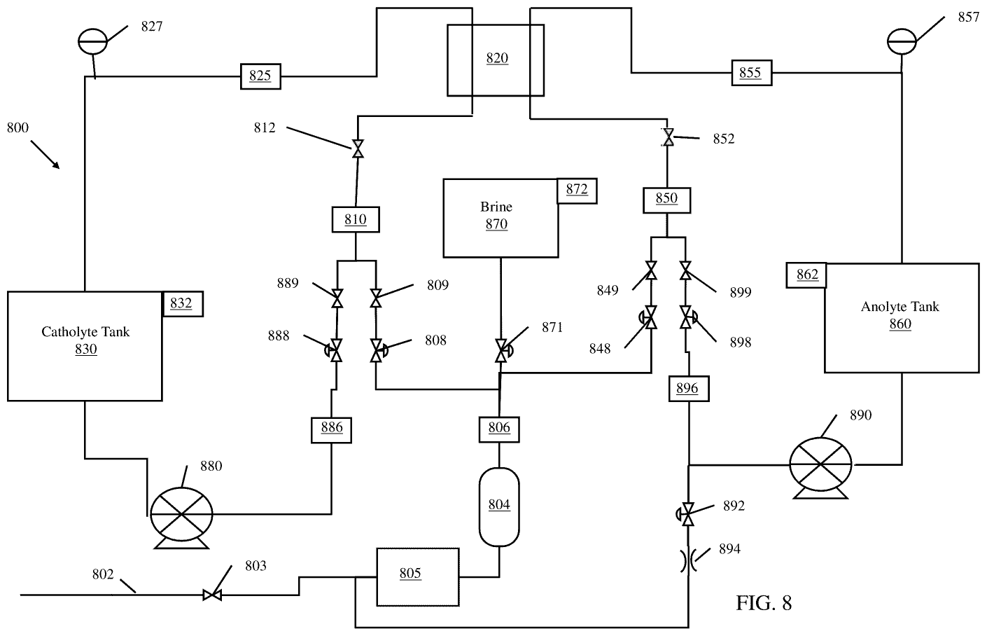

Turning to FIG. 8, a detailed schematic block diagram of an electrolytic system 800 is provided in accordance with a further particular illustrative example that is a variation of the system 600 depicted in FIG. 6. In the electrolytic system 800, input water is provided via an input water line 802, through a valve 803 to a water softener 804. Softened water output from the water softener 804 is provided to further fluid processing/handling components of the electrolytic system 800 after passing through a softened water pressure sensor 806. In the illustrative example, a brine tank 670 is provided as well as a catholyte pump 680 and an anolyte pump 690.

However, in a variation of the system 600 of FIG. 6, the system 800 includes an auxiliary disinfecting fluid branch from the anolyte pump 890 through a solenoid valve 892 and a flow restrictor 894 (e.g. a check valve), to an input of a reservoir 805 that provides a mixing/holding vessel for enabling the anolyte from the anolyte tank 860 to sanitize water provided from the input water line 802.

With continued reference to FIG. 8, a catholyte supply branch from an output of the softened water pressure sensor 806 includes a first catholyte supply solenoid valve 808 and a first catholyte supply check valve 809 through which softened water flows to a catholyte flow meter 810 and a catholyte flow control valve 812 before being provided as an input flow to a first (cathode) side of an electrolytic cell 820. A corresponding catholyte output flow, having passed through the electrolytic cell 820, is an electrolyzed solution that passes via a conduit, including a catholyte output flow sensor 825 and a catholyte pH sensor 827, for storage in a catholyte storage tank 830. The catholyte storage tank 830 is provided with catholyte sensors 832 that, by way of example, include a catholyte level sensor and a catholyte quality sensor. An output of the catholyte storage tank 830 is coupled via a supply line to an input of the catholyte pump 880. An output of the catholyte pump 880 is provided as an input to a catholyte supply line including a catholyte pressure sensor 886, a second catholyte supply solenoid valve 888 and a second catholyte supply check valve 889 through which catholyte flows to the catholyte flow meter 810.

With continued reference to FIG. 8, an anolyte supply branch from the output of the softened water pressure sensor 806 includes a first anolyte supply solenoid valve 848 and a first anolyte supply check valve 849 through which softened water flows to an anolyte flow meter 850 and an anolyte flow control valve 852 before being provided as an input flow to a second (anode) side of the electrolytic cell 820. A corresponding anolyte output flow, having passed through the electrolytic cell 820, is an electrolyzed solution that passes via a conduit, including an anolyte output flow sensor 855 and an anolyte pH sensor 857, for storage in an anolyte storage tank 860. The anolyte storage tank 860 is provided with anolyte sensors 862 that, by way of example, include an anolyte level sensor and an anolyte quality sensor. An output of the anolyte storage tank 860 is coupled via a supply line to an input of the anolyte pump 890. An output of the anolyte pump 890 is provided as an input to an anolyte supply line including an anolyte pressure sensor 896, a second anolyte supply solenoid valve 898 and a second anolyte supply check valve 899 through which anolyte flows to the anolyte flow meter 850.

With continued reference to FIG. 8, a brine tank supply branch from the output of the softened water pressure sensor 806 includes a brine tank supply solenoid valve 871 through which softened water is supplied to the brine tank 870. The brine tank 870 is provided with brine sensors 832 that, by way of example, include a brine level sensor and a brine quality sensor.

In a further illustrative example of the above described illustrative examples, captured rainwater is utilized as input to the systems illustratively depicted herein to feed the electrolytic systems. Rainwater is formed “softened” and can be utilized as the sole water source for the system alone, or in combination with any of the illustrative examples of electrolytic system depicted/described herein (RO system feed, recirculating storage). Chemical disinfection of rainwater can utilize the recirculation illustrative example within the same system as disinfectant is already present in the acidic anolyte solution.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred illustrative examples of the present disclosure are described herein, including the best mode known to the inventors for carrying out the invention. Variations of those illustrative examples may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for producing both cleaning and disinfecting solutions from respective outputs of an electrolytic cell, the system comprising:
a reverse osmosis (RO) unit comprising a membrane for purifying water, and producing as output:
an RO effluent, and
an RO water product;
an electrochemical activation system (ECAS) including the electrolytic cell configured to:
receive a catholyte input flow on a cathode cell side to produce a catholyte cleaning fluid, and
receive an anolyte input flow on an anode cell side to produce an anolyte disinfecting fluid,
wherein at least one of the catholyte input flow and/or the anolyte input flow is provided from at least one of the RO effluent and/or the RO water product; and
a plurality of storage tanks including:
a catholyte tank holding the catholyte cleaning fluid, and
an anolyte tank holding the anolyte disinfecting fluid.

2. The system of claim 1, wherein the catholyte input flow is provided from the RO effluent.

3. The system of claim 1, wherein the anolyte input flow is provided from the RO water product.

4. The system of claim 1, wherein the catholyte input flow is provided from the RO effluent, and wherein the anolyte input flow is provided from the RO water product.

5. The system of claim 1, wherein the system comprises a catholyte recirculation line coupled to provide the catholyte cleaning fluid as an input to the cathode cell side of the electrolytic cell.

6. The system of claim 5, wherein the system is configured with controllable valves facilitating mixing a variable amount of the catholyte cleaning fluid from the catholyte recirculation line and a source of input to the cathode cell side of the electrolytic cell.

7. The system of claim 1, wherein the system comprises an anolyte recirculation line coupled to provide the anolyte disinfecting fluid as an input to the anode cell side of the electrolytic cell.

8. The system of claim 7, wherein the system is configured with controllable valves facilitating mixing a variable amount of the anolyte disinfecting fluid from the anolyte recirculation line and a source of input to the anode cell side of the electrolytic cell.

9. The system claim 1, further comprising at least one pH sensor configured to sense pH of an output flow of the electrolytic cell.

10. The system of claim 9, wherein the at least one pH sensor is configured to sense pH of the catholyte cleaning fluid.

11. The system of claim 9, wherein the at least one pH sensor is configured to sense pH of the anolyte disinfectant fluid.

12. The system of claim 1, wherein a fluid quality sensor is provided for a catholyte tank containing the catholyte cleaning fluid.

13. The system of claim 12, wherein the fluid quality sensor is a conductivity sensor.

14. The system of claim 1, wherein a fluid quality sensor is provided for an anolyte tank containing the anolyte cleaning fluid.

15. The system of claim 12, wherein the fluid quality sensor is a conductivity sensor.

16. The system of claim 1, further comprising at least one water softener provided between a fluid source and the electrolytic cell.

17. The system of claim 16, wherein the at least one water softener includes an RO effluent softener configured to preprocess the RO effluent provided to the cathode cell side of the electrolytic cell.

18. The system of claim 16, wherein the at least one water softener includes an RO water product softener configured to preprocess the RO water product provided to the anode cell side of the electrolytic cell.

19. The system of claim 1, wherein a single input fluid source is used to supply both the catholyte input flow to the cathode cell side and the anolyte input flow to the anode cell side of the electrolytic cell.

20. A system for producing both cleaning and disinfecting solutions from respective outputs of an electrolytic cell, the system comprising:
an input water line providing an input water flow;
an electrochemical activation system (ECAS) coupled to the input water line for receiving the input water flow, wherein the ECAS is configured to produce a catholyte cleaning fluid and an anolyte disinfecting fluid from the input water flow, and wherein the ECAS includes the electrolytic cell configured to:
receive a catholyte input flow on a cathode cell side to produce the catholyte cleaning fluid, and
receive an anolyte input flow on an anode cell side to produce the anolyte disinfecting fluid; and
a plurality of storage tanks including:
a catholyte tank holding the catholyte cleaning fluid, and
an anolyte tank holding the anolyte disinfecting fluid,
wherein the system comprises at least one recirculation line and controllable valves configured to controllably supply a recirculated fluid from at least one of the plurality of storage tanks to at least one input flow taken from the group consisting of:
the catholyte input flow, and
the anolyte input flow.

21. The system of claim 20, wherein the at least one recirculation line comprises a catholyte recirculation line providing the catholyte cleaning fluid from the catholyte tank to the catholyte input flow of the electrolytic cell.

22. The system of claim 21, wherein the controllable valves facilitate mixing a variable amount of the catholyte cleaning fluid from the catholyte recirculation line and a source of input to the cathode cell side of the electrolytic cell.

23. The system of claim 20, wherein the at least one recirculation line comprises an anolyte recirculation line providing the anolyte disinfecting fluid from the anolyte tank to the anolyte input flow of the electrolytic cell.

24. The system of claim 23, wherein the controllable valves facilitate mixing a variable amount of the anolyte disinfecting fluid from the anolyte recirculation line and a source of input to the anode cell side of the electrolytic cell.

25. The system of claim 20, wherein the at least one recirculation line comprises an anolyte recirculation line providing the anolyte disinfecting fluid from the anolyte tank to a source water line upstream of the cathode cell side of the electrolytic cell.

26. The system of claim 25, wherein the anolyte recirculation line is coupled to provide the anolyte disinfecting fluid upstream of a softener supplying both the cathode cell side and the anode cell side of the electrolytic cell.
